(19) United States
(12) Patent Application Publication
(10) Pub. No.: US 2025/0355391 A1
(43) Pub. Date: Nov. 20, 2025

(54) IMAGE FORMING APPARATUS

(71) Applicant: CANON KABUSHIKI KAISHA, Tokyo (JP)

(72) Inventors: KOHEI UENO, Tokyo (JP); KOHEI DENO, Ibaraki (JP); YUKINOJO TODA, Saitama (JP)

(21) Appl. No.: 19/206,382

(22) Filed: May 13, 2025

(30) Foreign Application Priority Data
May 17, 2024 (JP) 2024-081284

(51) Int. Cl. G03G 15/00

(52) U.S. Cl. CPC G03G 15/5029; G03G 15/6561; G03G 15/6579; G03G 2215/00734

(57) ABSTRACT

An image forming apparatus includes an image bearing member, an image forming unit, a transfer unit, a conveyance unit, a width position detection unit, and a control unit. The width position detection unit detects a width position of a sheet in a sheet width direction. The control unit acquires a first width position of a first sheet based on a detection result of the width position detection unit, and adjust a width position of an image to be transferred to a second sheet subsequent to the first sheet on the image bearing member based on the first width position, where the first width position is a width position of the first sheet at a first conveyance direction position that is a position of the first sheet located in a central region among three regions into which the first sheet is equally divided in a sheet conveyance direction.

### BACKGROUND

### Field of the Technology

The present disclosure relates to an image forming apparatus that forms an image on a sheet.

### Description of the Related Art

Conventionally, in an image forming apparatus that forms an image on a sheet, positional accuracy between the sheet and an image written on the sheet is required. In particular, as a unit for correcting a misalignment in a sheet width direction orthogonal to a sheet conveyance direction, the following image forming apparatus has been developed (see Japanese Patent Laid-Open No. 2006-293280 A). This image forming apparatus includes a detection unit that detects a side edge position in the sheet width direction near a registration roller pair disposed upstream of a transfer unit that transfers a toner image on an intermediate transfer member to a sheet. Then, a latent image is formed on an image bearing member using the side edge position of the sheet based on an amount of detection by the detection unit as a reference, and a writing position is corrected in accordance with the sheet position.

However, in the image forming apparatus described in Japanese Patent Laid-Open No. 2006-293280 A, the position of the side edge of the sheet is read by the CIS sensor at a leading edge of the sheet, and the writing position is controlled based on a detection result of the CIS sensor. When the image forming position is adjusted in accordance with the side edge position at the leading edge portion of the sheet, an image may be more greatly misaligned with respect to the sheet at the trailing edge portion of the sheet than at the leading edge portion of the sheet.

### SUMMARY

The present disclosure is directed to provide an image forming apparatus that improves positional accuracy of an image formed on a sheet in a sheet width direction.

According to a first aspect of the present disclosure, an image forming apparatus includes an image bearing member, an image forming unit configured to form an image on the image bearing member, a transfer unit configured to transfer the image formed on the image bearing member by the image forming unit to a sheet, a conveyance unit configured to convey the sheet on which the image is transferred by the transfer unit in a sheet conveyance direction, a width position detection unit configured to detect a width position of the sheet in a sheet width direction intersecting the sheet conveyance direction, and a control unit configured to adjust a position of the image on the image bearing member. The control unit is configured to acquire a first width position of a first sheet based on a detection result of the width position detection unit and adjust a width position of an image to be transferred to a second sheet subsequent to the first sheet on the image bearing member based on the first width position, where the first width position is a width position of the first sheet at a first conveyance direction position that is a position of the first sheet located in a central region among three regions into which the first sheet is equally divided in the sheet conveyance direction.

Features of the present disclosure will become apparent from the following description of embodiments with reference to the attached drawings. The following description of embodiments are described by way of example.

### BRIEF DESCRIPTION OF THE DRAWINGS

FIG. 1 is a cross-sectional view illustrating an image forming apparatus according to a first embodiment.

FIG. 2 is a block diagram illustrating a control system of the image forming apparatus according to the first embodiment.

FIG. 3A is a diagram illustrating a sheet conveyance unit according to the first embodiment, and is a diagram when a leading edge of a sheet is detected in a first conveyance unit.

FIG. 3B is a diagram illustrating the sheet conveyance unit according to the first embodiment, and is a diagram when the leading edge of the sheet is detected in a second conveyance unit.

FIG. 4A is a diagram illustrating the sheet conveyance unit according to the first embodiment, and is a diagram when a sheet center position is detected in the first conveyance unit.

FIG. 4B is a diagram illustrating the sheet conveyance unit according to the first embodiment, and is a diagram when the sheet center position is detected in the second conveyance unit.

FIG. 5A is a diagram illustrating the first conveyance unit according to the first embodiment, and is a diagram when a leading edge of a sheet is detected.

FIG. 5B is a diagram illustrating the first conveyance unit according to the first embodiment, and is a diagram when an image is transferred to the sheet.

FIG. 6A is a diagram illustrating the first conveyance unit according to the first embodiment, and is a diagram when a center position of a sheet is detected.

FIG. 6B is a diagram illustrating the first conveyance unit according to the first embodiment, and is a diagram when a trailing edge of the sheet is detected.

FIG. 7 is a first half of a flowchart illustrating a procedure when double-sided printing is performed by the image forming apparatus according to the first embodiment.

FIG. 8 is a second half of the flowchart illustrating the procedure when double-sided printing is performed by the image forming apparatus according to the first embodiment.

FIG. 9A is a diagram illustrating a first conveyance unit according to a second embodiment, and is a diagram when a leading edge of a sheet is detected.

FIG. 9B is a diagram illustrating the first conveyance unit according to the second embodiment, and is a diagram when a trailing edge of the sheet is detected.

FIG. 10 is a first half of a flowchart illustrating a procedure when double-sided printing is performed by an image forming apparatus according to a third embodiment.

FIG. 11 is a second half of the flowchart illustrating the procedure when double-sided printing is performed by the image forming apparatus according to the third embodiment.

### DESCRIPTION OF THE EMBODIMENTS

Hereinafter, embodiments according to the present disclosure will be described with reference to the drawings.

### First Embodiment

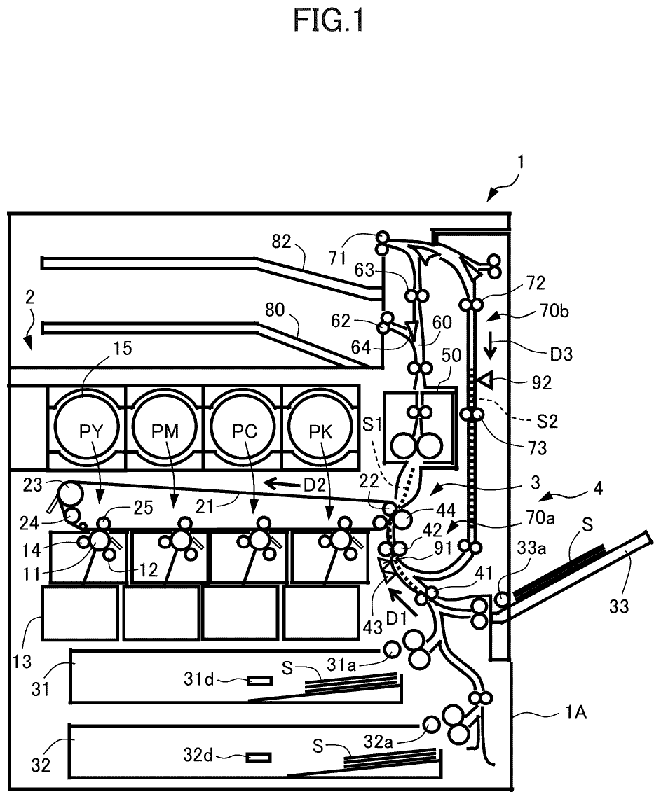

An image forming apparatus 1 according to a first embodiment will be described with reference to FIGS. 1 to 8. First, a schematic configuration of the image forming apparatus 1 according to the present embodiment will be described with reference to FIG. 1.

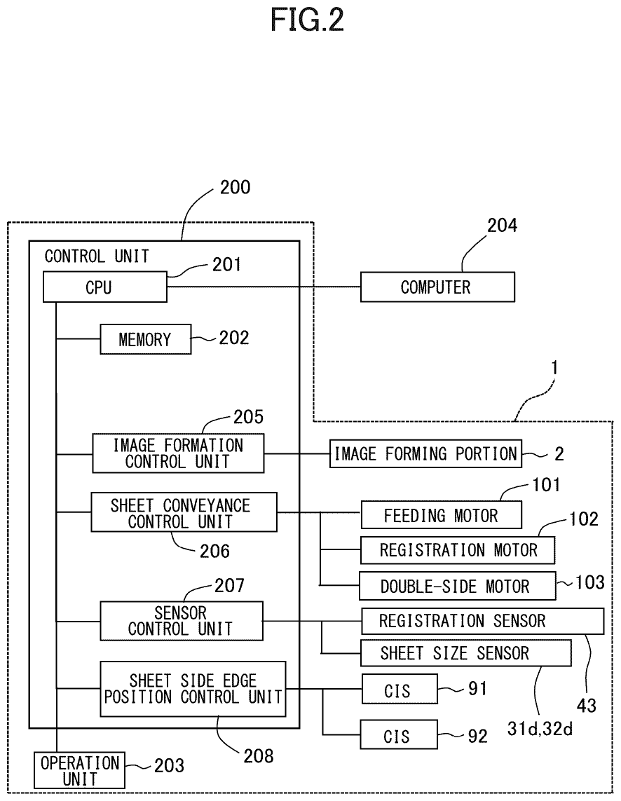

FIG. 1 is a cross-sectional view illustrating the schematic configuration of the image forming apparatus 1 according to the present embodiment when viewed from the front side. The depth direction in the plane of the drawing when viewed from the front side F of the main body is the back side B of the main body. The image forming apparatus 1 is a tandem-intermediate transfer-type laser beam printer using an electrophotographic process. The image forming apparatus 1 can form and output a full-color or monochrome image corresponding to print image data output from an external computer 204 (see FIG. 2) connected to a control unit 200 on a sheet S that is a recording medium.

### Image Forming Apparatus

The image forming apparatus 1 includes an apparatus body 1A, an image forming portion 2 that forms an image on a sheet S, a secondary transfer unit 3, and a sheet conveyance unit 4.

### Image Forming Portion

The image forming portion 2 forms an image on the conveyed sheet S. The image forming portion 2 includes four process cartridges PY, PM, PC, and PK that form toner images of four colors, yellow (Y), magenta (M), cyan (C), and black (K), respectively, an exposure unit 13, and an intermediate transfer belt 21. The four process cartridges PY, PM, PC, and PK have the same configuration except that colors of images to be formed are different. Therefore, only the configuration and the image forming process of the process cartridge PY will be described, and the description of the process cartridges PM, PC, and PK will be omitted. The image forming portion 2 includes a secondary transfer inner roller 22 and a primary transfer roller 25.

The process cartridge PY includes a photosensitive drum 11 that is a drum-type electrophotographic photosensitive member, a charging roller 12, and a developing roller 14. The photosensitive drum 11 is rotatably supported by the image forming apparatus 1, and is driven to rotate by a driving unit (not illustrated). The photosensitive drum 11 is formed by providing a photoconductive layer such as an organic photoconductor (OPC) on an outer circumferential surface of an aluminum cylinder. The charging roller 12 charges the photosensitive drum 11. The charging roller 12 is formed of a core metal and a conductive elastic member surrounding the periphery of the core metal, and is disposed in contact with the surface of the photosensitive drum 11 to rotate together with the photosensitive drum 11, and a charging bias is applied to the charging roller 12 by a power source (not illustrated). The developing roller 14 attaches a toner of a different color (yellow, magenta, cyan, or black) to the surface of the photosensitive drum 11 for each of the process cartridges PY, PM, PC, and PK. The developing roller 14 develops an electrostatic latent image with the toner attached to the electrostatic latent image on the surface of the photosensitive drum 11, thereby forming a toner image on the surface of the photosensitive drum 11. The toner is supplied from a toner cartridge 15 to each developing roller 14.

The exposure unit 13 accommodates, in a casing, a laser light source that emits laser light and various optical members for guiding the laser light emitted from the laser light source to the corresponding photosensitive drum 11 and performing deflection scanning. The exposure unit 13 irradiates the charged surface of the photosensitive drum 11 with laser light based on image information to form an electrostatic latent image. Thereafter, a predetermined pressure and a predetermined electrostatic bias are applied by the primary transfer roller 25, and the toner image is transferred onto the intermediate transfer belt 21.

The intermediate transfer belt 21 is stretched by rollers such as a driving roller 23, a tension roller 24, and a secondary transfer inner roller 22, and is driven to be conveyed in a direction D2. Each of the image forming processes for the colors Y, M, C, and K processed in parallel is performed at a timing when the toner image is superimposed on the toner image of the upstream color primarily transferred onto the intermediate transfer belt 21. As a result, a full-color toner image is finally formed on the intermediate transfer belt 21, and this toner image is conveyed to the secondary transfer unit 3.

The secondary transfer unit 3 includes an intermediate transfer belt 21 and a secondary transfer outer roller 44 disposed to face the secondary transfer inner roller 22 with the intermediate transfer belt 21 interposed therebetween. The secondary transfer unit 3 has a transfer nip portion formed by the secondary transfer inner roller 22 and the secondary transfer outer roller 44 facing each other, and transfers the toner image onto the sheet S (secondary transfer) by applying a predetermined pressure and a predetermined electrostatic bias. The secondary transfer unit 3 is an example of an image forming position, and is a position of an image to be formed on a sheet by the image forming portion 2, that is, a position of an image to be transferred to the sheet S by the secondary transfer unit 3. In the present embodiment, the photosensitive drum 11 is an example of an image bearing member. The developing roller 14 is an example of an image forming unit, and forms an image on the photosensitive drum 11. The secondary transfer unit 3 is an example of a transfer unit, and transfers the image formed on the photosensitive drum 11 by the developing roller 14 to the sheet S.

### Sheet Conveyance Apparatus

The sheet conveyance unit 4 includes sheet cassettes 31 and 32, feeding units 31a and 32a, a first conveyance unit 70a, and a second conveyance unit 70b. The sheet cassettes 31 and 32 are provided with sheet size sensors 31d and 32d, respectively, and detect sizes of sheets accommodated therein. The sheet size sensors 31d and 32d are examples of length detection units, and detect lengths of sheets S in the sheet conveyance direction. The first conveyance unit 70a conveys the sheet S when an image is formed on a front side that is a first side of the sheet S. The second conveyance unit 70b reverses (reverses the front and the back) the sheet S that has passed through the first conveyance unit 70a, and conveys the sheet S when an image is formed on a back side that is a second side opposite to the first side of the sheet S. The first conveyance unit 70a is an example of a conveyance unit that conveys the sheet S on which the image is transferred by the secondary transfer unit 3 in the sheet conveyance direction, and includes a pre-registration roller pair 41 and a registration roller pair 42. The pre-registration roller pair 41 and the registration roller pair 42 are disposed upstream of the secondary transfer unit 3 in the sheet conveyance direction.

The sheet S is fed from the feeding unit 31a, passes through the pre-registration roller pair 41, and is conveyed to the registration roller pair 42. The pre-registration roller pair 41 and the registration roller pair 42 correct skewing of the sheet S. Specifically, a leading edge of the sheet S to be conveyed is brought into abutment against a nip portion of the registration roller pair 42 that is stopped. In this manner, the pre-registration roller pair 41 loops the sheet S to perform correction of skewing. The registration roller pair 42 conveys the sheet S to the secondary transfer unit 3 in accordance with the timing at which the toner image on the intermediate transfer belt 21 is transferred to the sheet S. That is, the registration roller pair 42 nips and conveys the sheet S after correcting the skewing of the sheet S while the leading edge of the sheet S abuts against the registration roller pair 42 in the sheet conveyance direction in a state where the rotation is stopped.

After the toner image is transferred to the sheet S by the secondary transfer unit 3, the sheet S is conveyed to a fixing unit 50, where the toner image is fused and fixed to the sheet S by applying heat and pressure. After fixation, the sheet S is conveyed to a sheet discharge conveyance unit 60, where the conveyance path is switched by a switching member 64 depending on whether the sheet passing mode is a single-side mode or a double-side mode. When the sheet passing mode is a single-side mode, the sheet is stacked on a sheet discharge tray 80 by a sheet discharge roller pair 62.

On the other hand, when the sheet passing mode is a double-side mode, a reverse conveyance roller pair 71 is reversed after being temporarily stopped in a state where a trailing edge of the sheet S remains on the reverse conveyance roller pair 71 by a predetermined distance. The reverse conveyance roller pair 71 is an example of a reversing unit, and reverses the sheet S on which an image has been formed in the image forming portion 2, that is, the sheet S on which the image has been transferred to the first side by the secondary transfer unit 3. Then, the sheet S is conveyed back to the registration roller pair 42 via the second conveyance unit 70b, and the image forming portion 2 performs image formation and fixation on the second side. The second conveyance unit 70b is an example of a re-conveyance path, and re-conveys the sheet S reversed by the reverse conveyance roller pair 71 to the secondary transfer unit 3 via the registration roller pair 42. After fixation, the sheet S is stacked on the sheet discharge tray 80 or 82 by the sheet discharge roller pair 62 or 71 via the switching member 64.

### Control System

Next, the control unit 200 and the control system of the image forming apparatus 1 will be described with reference to FIG. 2. The control unit 200 includes functional units such as a central processing unit (CPU) 201, a memory 202, an image formation control unit 205, a sheet conveyance control unit 206, a sensor control unit 207, and a sheet side edge position control unit 208. The CPU 201 realizes various processes performed by the image forming apparatus 1 by executing a predetermined control program or the like. The memory 202 is, for example, a random access memory (RAM), a read only memory (ROM), or the like, and stores various programs and various types of data in a predetermined storage area.

The operation unit 203 includes, for example, a touch panel or the like provided on the top of the apparatus body 1A, and receives various types of information regarding sheets used by the user for printing (size information, grammage information, surface property information, and the like), and various operations performed by the user such as an instruction to execute or stop the printing. The image formation control unit 205 issues an instruction to the image forming portion 2 including the exposure unit 13 to control image formation. For example, the control unit 200 adjusts the position of the image on the photosensitive drum 11. The sheet conveyance control unit 206 controls the conveyance of the sheet S by issuing instructions to a feeding motor 101, a registration motor 102, a double-side motor 103, and the like, and controlling the driving of various conveyance roller pairs. The sensor control unit 207 controls the sheet size sensors 31d and 32d, the registration sensor 43, and the like to start or stop detection, and receives detection results of these sensors. The sheet side edge position control unit 208 receives detection signal values of CISs 91 and 92, which will be described below, and converts the detection signal values into sheet side edge positions. Note that various types of information regarding sheets to be used for printing can be received, for example, via the computer 204 connected via a network.

### Detection of Sheet Position in Sheet Width Direction

Next, as a specific configuration of the sheet conveyance unit 4, a configuration for detecting a side edge position in the sheet width direction (a position of an end portion in the width direction of the sheet) will be described. Note that the image forming apparatus 1 according to the present embodiment will be described as adopting, as an example, a center-based sheet conveyance method in which a sheet is conveyed with a center line of a sheet conveyance path in a width direction orthogonal to the sheet conveyance direction and a center line of the sheet in the sheet width direction being aligned with each other.

The sheets S, which are materials to be transferred, are stacked and stored on the sheet cassettes 31 and 32 and a manual sheet feeder 33 by size. In order to form images within appropriate ranges of the sheets S, it is necessary for the image forming apparatus 1 to recognize the sizes of the stored sheets S. The sheet cassettes 31 and 32 include side regulating plates that regulate a position in the sheet width direction, thereby making it possible to suppress skewing and positional misalignment in the width direction of the sheet S that occurs between the feeding units 31a and 32a for the sheet S and each conveyance roller pair.

However, in reality, a slight gap may occur between the side regulating plate and the sheet S. If the gap occurs, the sheet S may be skewed or positionally misaligned in the sheet width direction when the sheet S is fed and conveyed. In a conventional image forming apparatus, a sheet may be conveyed to the secondary transfer unit 3 in a state where the sheet position is misaligned in the sheet width direction, and the image formed on the first side of the sheet S may be misaligned in the width direction.

Further, the sheet S reversed by the reverse conveyance roller pair 71 in a switched-back manner is conveyed back to the image forming portion 2 via the second conveyance unit 70b. At this time, when the sheet S is conveyed in the reverse conveyance roller pair 71 while being nipped between one pair of rollers, both the pair of rollers and the sheet S may be misaligned in the sheet width direction. Before being switched back, the sheet S is conveyed from the fixing unit 50 to the reverse conveyance roller pair 71. After being switched back, the sheet S is conveyed from the reverse conveyance roller pair 71 to double-side conveyance roller pairs 72 and 73, and is nipped and conveyed by multiple roller pairs. Therefore, the sheet S may be misaligned or skewed in the width direction due to misalignment between the roller pairs. In this case, the image formed on the second side of the sheet S may is misaligned in the sheet width direction.

In this manner, both the images formed on the first side and the second side of the sheet S may be positionally misaligned in the width direction. In contrast, by providing the CISs 91 and 92 that detect side edge positions on both the first side and the second side, positional misalignment amounts of the side edge positions in the sheet width direction is detected, and latent images are formed on the image bearing member with the sheet side edge positions based on the detected amounts as references. As a result, it is possible to perform correction so that the image formation position is written in accordance with the sheet position.

However, in a case where the sheet side edge portion is read, reading positions are different on the first side and the second side, and which causes a problem that the positions of the images are misaligned in the main scanning direction on the front and back side. Furthermore, in the case where the sheet side edge portion is read, if the cutting accuracy of the sheet S is poor, there is a problem that, when an image is formed in accordance with a sheet side edge position of a leading edge portion of the sheet, there is a large misalignment in the sheet width direction between the sheet S and the image at a trailing edge portion of the sheet. That is, in a case where the cutting accuracy of the sheet is poor, an image is likely to be misaligned in the sheet width direction at the trailing edge of the sheet. Furthermore, in a case where double-sided printing is performed, the sheet conveyance direction is reversed, which may cause positions of front and back images to be misaligned in the sheet width direction. Therefore, in the present embodiment, a positional misalignment of an image in the sheet width direction with respect to the sheet S is reduced by correcting the writing position using the center position of the side edge portion of the sheet in the sheet conveyance direction as a reference.

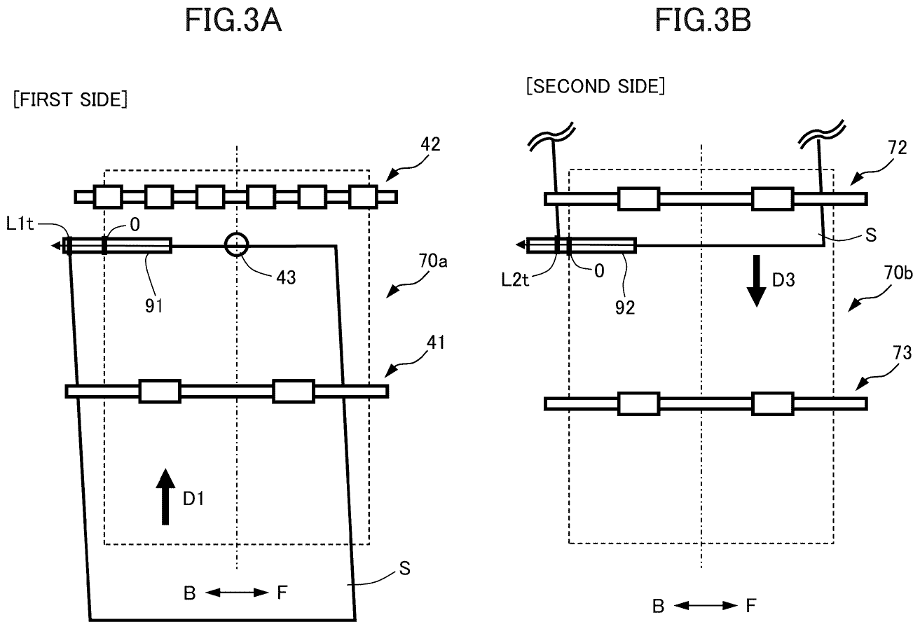

FIGS. 3A and 3B illustrate a state in which reading positions are different on the first side and the second side as described above as a problem. An alternate long and short dash line at the center portion in each of FIGS. 3A and 3B represents the center in the sheet width direction, and based on detection results of the CISs 91 and 92, the control unit 200 calculates amounts of misalignments between the normal position (design target position) and the detection results. By controlling amounts of corrections for writing images in the exposure unit 13 based on the amounts of misalignments, images to be formed on the first side and the second side of the sheet S can be positioned with high accuracy. That is, the image forming portion 2 can change a position of an image to be formed on the sheet S, and the control unit 200 adjusts a position of an image to be formed on the sheet S by the image forming portion 2.

As illustrated in FIG. 3A, the first conveyance unit 70a includes a CIS 91 that detects a side edge position on the first side of the sheet S, and a registration sensor 43. The CIS 91 is disposed upstream of the registration roller pair 42 in the sheet conveyance direction. In FIG. 3A, the CIS 91 detects a side edge position of the sheet S at a sheet leading edge on the first side of the sheet S, that is, a positional misalignment amount L1t in the sheet width direction. In the present embodiment, the CIS 91 and the registration sensor 43 are arranged side by side in a direction orthogonal to the sheet conveyance direction. As a result, the CIS 91 detects a side edge position at the leading edge of the sheet or at the trailing edge of the sheet at a timing that is synchronized with the timing at which the registration sensor 43 detects the leading edge or trailing edge of the sheet. Here, the CIS 91 detects the side edge position on the first side of the sheet S, but it is also possible to detect a side edge position on the second side of the sheet S. That is, the CIS 91 is an example of a width position detection unit and is an example of a first width position detection unit, and detects a position of the sheet S in the sheet width direction intersecting the sheet conveyance direction.

The CIS 91 is provided at a position biased to one side from the center in the sheet width direction of the sheet S with respect to the sheet conveyance direction indicated by the direction D1, that is, on the back side B of the main body in the present embodiment, for the sheet S conveyed while being nipped by the pre-registration roller pair 41. This is because it is sufficient to detect a side edge position of only one side of the sheet S for correcting the image forming position on the sheet S. By providing the CIS 91 on the back side B of the main body, the image formed on the sheet S can be based on the left side with respect to the sheet conveyance direction. In addition, the CIS 91 is disposed to be able to detect side edge positions of sheets having the smallest width and the largest width among the sheet sizes applied to the image forming apparatus 1.

On the other hand, as illustrated in FIG. 3B, the second conveyance unit 70b includes a CIS 92 that detects a side edge position on the second side of the sheet S before the sheet S reversed in the switched-back manner by the reverse conveyance roller pair 71 is conveyed back to the image forming portion 2. In FIG. 3B, the CIS 92 detects a positional misalignment amount L2t in the sheet width direction at the leading edge on the second side of the sheet S. The CIS 92 is an example of a second width position detection unit, and is disposed in the second conveyance unit 70b to detect a position of the sheet S in the sheet width direction.

The CIS 92 is provided at a position biased to one side from the center in the sheet width direction of the sheet S with respect to the sheet conveyance direction indicated by the direction D3, that is, on the back side B of the main body in the present embodiment, for the sheet S conveyed while being nipped by the double-side conveyance roller pair 72. This is because, similarly to the first side, it is sufficient to detect a side edge position of only one side of the sheet S for correcting the image forming position on the sheet S. By providing the CIS 92 on the back side B of the main body, the image formed on the sheet S can be based on the left side with respect to the sheet conveyance direction. In addition, the CIS 92 is disposed to be able to detect side edge positions of sheets having the smallest width and the largest width among the sheet sizes applied to the image forming apparatus 1.

Here, it can be seen that the positional misalignment amount L1t of the leading edge of the sheet in the width direction, which is a detection value detected by the CIS 91 illustrated in FIG. 3A, is different from the positional misalignment amount L2t of the leading edge of the sheet in the width direction, which is a detection value detected by the CIS 92 illustrated in FIG. 3B. This may be caused in a case where the sheet S runs obliquely or in a case where the orthogonality of the edge portion of the sheet is poor due to the cutting characteristic of the sheet S. In such a sheet state, the sheet S conveyed while being nipped by the pre-registration roller pair 41 and the sheet S reversed in a switched-back manner by the reverse conveyance roller pair 71 are in a relationship in which the leading and trailing edges of the sheet S are reversed. As a result, the reading positions of the CISs 91 and 92 are misaligned.

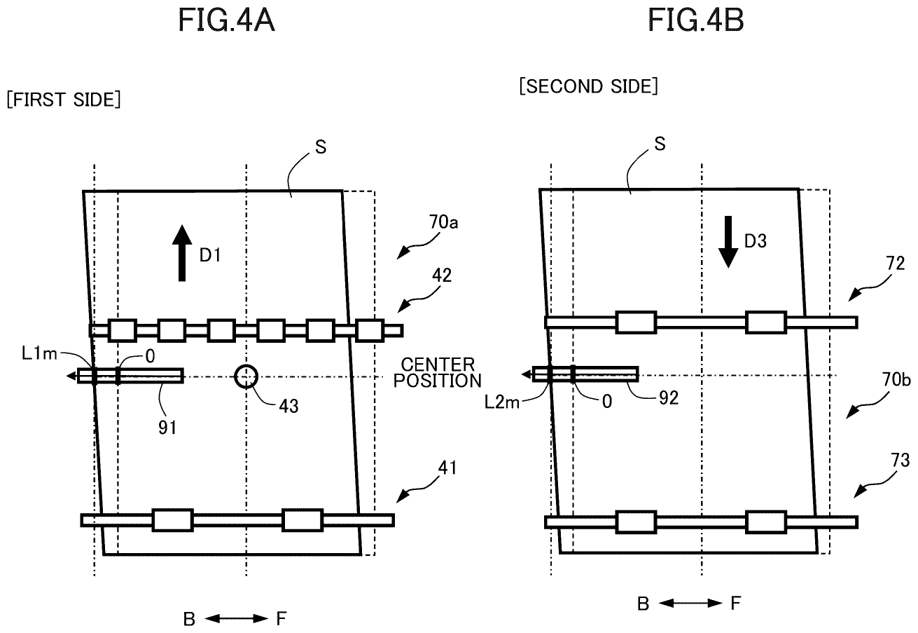

With respect to the problem that the detection positions of the CISs 91 and 92 illustrated in FIGS. 3A and 3B are misaligned between the first side and the second side when the detection positions are set to the leading edge of the sheet end, in the example illustrated in FIGS. 4A and 4B, the detection positions of the CISs 91 and 92 are set to the center position in the sheet conveyance direction of the sheet S. As illustrated in FIGS. 3A and 3B, when the misalignments of the sheet positions of the side edge portions on the first side and the second side are detected at the leading edge portion of the sheet, the reading positions of the CISs 91 and 92 are misaligned in a case where the sheet S runs obliquely or in a case where the orthogonality of the edge portion of the sheet is poor due to the cutting characteristic of the sheet S. If the image forming position is feedback-controlled in a state where the reading positions of the CISs 91 and 92 are misaligned, the image matching on the front and back sides is also misaligned, and accuracy is not obtained.

The first side and the second side have a relationship in which the leading and trailing edges are reversed. Therefore, when the CISs 91 and 92 perform detection at the center position in the sheet conveyance direction, it is possible to reduce the amount of misalignment in the detection position in the width direction between L1m and L2m on the front and back sides, the first and second sides, of the sheet as compared with that when detecting the side edge portion at the leading edge of the sheet. In addition, both the CIS 91 and the CIS 92 are disposed on the back side B of the main body, matching the detection criteria as sensors, which is advantageous from the viewpoint of detection accuracy. That is, the CISs 91 and 92 are disposed on the same side in the sheet width direction with respect to the center of the sheet conveyance region (see an alternate long and short dash line in FIG. 3A) where the sheet S is conveyed.

### Procedure for Detecting Side Edge Position in Sheet Width Direction and Correcting Image Forming Position During Double-Sided Printing

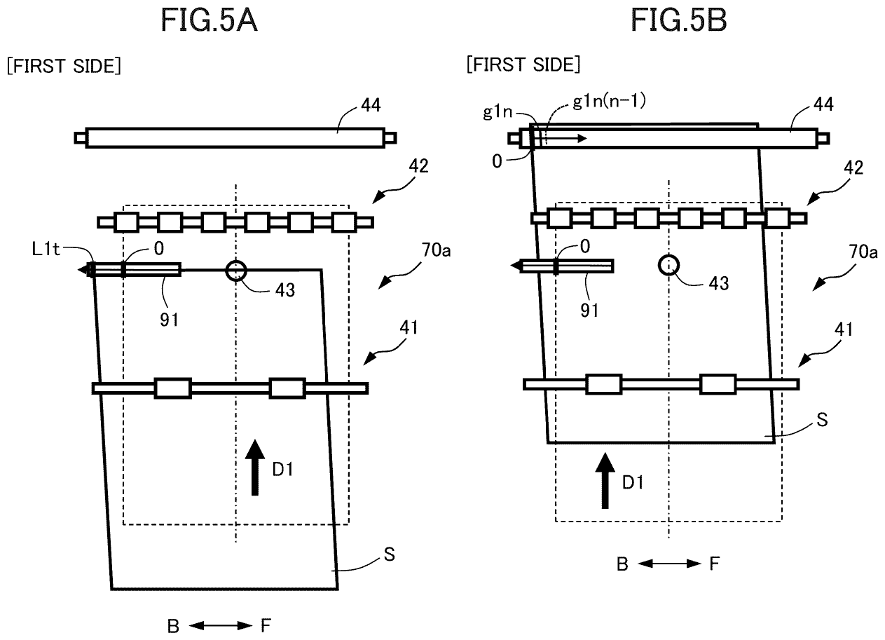

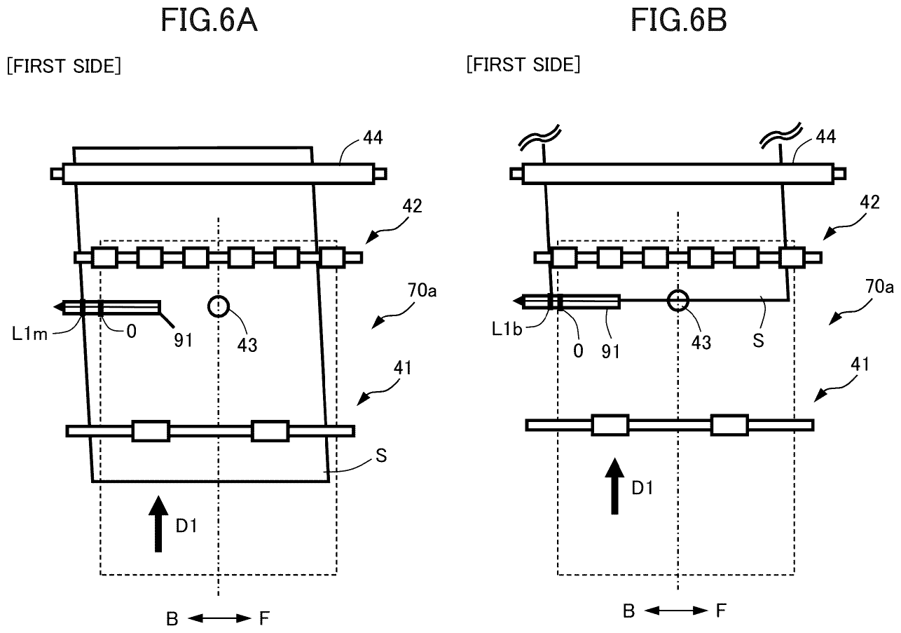

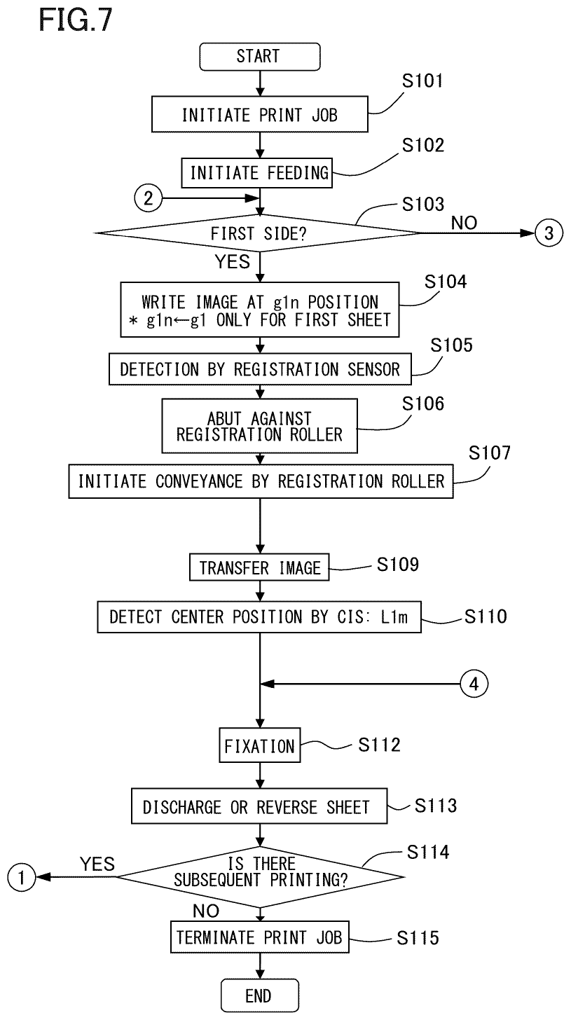

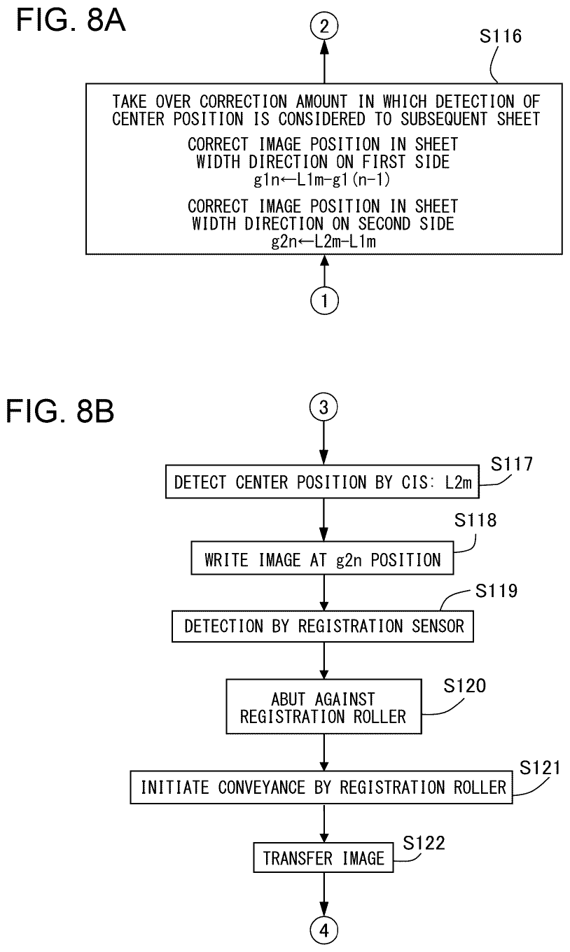

FIGS. 5A and 5B and FIGS. 6A and 6B are diagrams for explaining a method of detecting a side edge position in the width direction of the sheet S and correcting an image forming position in the sheet conveyance unit 4. Hereinafter, a processing procedure for the method of detecting the side edge position in the width direction of the sheet S and correcting the image forming position in the image forming apparatus 1 will be described with reference to flowcharts illustrated in FIGS. 7 and 8.

The control unit 200 initiates a print job when receiving a print execution instruction from a user via the operation unit 203 or the computer 204 (S101). Note that the user can designate the number of copies to be printed and the like, and can also designate the type of sheet to be used for printing. In addition, the control unit 200 acquires information on sizes of sheets accommodated in the sheet cassettes 31 and 32 using the sheet size sensors 31d and 32d. Alternatively, the information on sizes of sheets accommodated in the sheet cassettes 31 and 32 may be acquired based on sheet size information input from the operation unit 203 by the user.

The control unit 200 initiates feeding a sheet S (S102), and determines whether a first side is to be printed in the print job (S103). When it is determined that the first side is to be printed (S103: YES), the control unit 200 writes an image at a g1n position, which is an image writing position on the first side, the g1n position being g1 set in advance (S104). Here, g1, which is the g1n position on the first side of the first sheet, is a value based on a result of writing position adjustment performed at the time of shipment from the factory or the like, and is stored in the memory 202 as a fixed value unique to the main body. In addition, g1n for second and subsequent sheets during continuous sheet passage is calculated by feedback control, which will be described below. Here, n refers to an nth sheet printed in the print job.

Next, the sheet S is conveyed to the registration roller pair 42 in the first conveyance unit 70a. Here, it is assumed that, when viewed from the image forming portion 2 side, the conveyed sheet S is rotated and skewed in the counterclockwise direction with respect to the sheet conveyance direction, and is misaligned to the back side B, as illustrated in FIG. 5A. Note that a broken-line rectangle illustrated in FIG. 5A schematically illustrates a state in which the leading edge of the sheet S conveyed without skewing or lateral misalignment abuts on the nip portion of the registration roller pair 42, and at this time, the back side B is set to the positive direction with the side edge position in the sheet width direction as the zero point.

The control unit 200 acquires a detection result of the registration sensor 43 with respect to the leading edge of the conveyed sheet S (S105), and the leading edge of the sheet S abuts against the nip portion of the registration roller pair 42 that has stopped. Thereafter, the sheet S is fed by the pre-registration roller pair 41 by a set feeding amount, so that a predetermined amount of deflection is formed in the sheet S (S106). In this manner, the control unit 200 corrects the skewing of the sheet S, and further initiates driving the registration roller pair 42 to be rotated (S107) as illustrated in FIG. 5B.

The control unit 200 continues the conveyance by the registration roller pair 42, and transfers an image (toner image) onto the sheet S in the secondary transfer unit 3 (S109). As illustrated in FIG. 6A, the control unit 200 performs side edge position detection at the center position of the sheet S by the CIS 91 (S110), and stores a detection result L1m, for example, in the memory 202.

Here, the center position will be described. In the present embodiment, the center position of the sheet S in the sheet conveyance direction is set as a first detection position, serving as a first conveyance direction position, in the sheet conveyance direction. The control unit 200 adjusts a position at which an image is to be formed on the sheet S, as will be described below, based on a first width position of the sheet in the sheet width direction at the first detection position. The center position here is the center position of the sheet S in the sheet conveyance direction. For example, after the registration sensor 43 detects the leading edge of the sheet, the control unit 200 detects a side edge position by the CIS 91 at a timing when the sheet S is conveyed by a distance of ½ of the sheet length acquired in advance, and acquires the detected side edge position as the first width position. That is, the control unit 200 detects the first width position at the first detection position by the CIS 91 based on the length of the sheet S detected by the sheet size sensor 31d or 32d. That is, the control unit 200 is configured to acquire the first width position of the first sheet based on a detection result of the CIS 91, where the first width position is a width position of the first sheet at the first detection position that is a position of the first sheet located in a central region among three regions into which the first sheet is equally divided in the sheet conveyance direction.

Here, the control of detecting the side edge position at the center position of the sheet S is one of the characteristic controls of the image forming apparatus 1 according to the present embodiment. In general, the orthogonality of the sheet itself, that is, the angle between the leading edge side and the left edge side in the sheet conveyance direction, may not be exactly 90°. In the present embodiment, skewing is corrected using the leading edge side of the sheet S as a reference. For this reason, in a case where the perpendicular line drawn from the leading edge side along the sheet conveyance direction is not parallel to the left edge side, even if the image writing position in the sheet width direction for the sheet S is corrected by image position correction, the sheet S is gradually misaligned in the sheet width direction as the sheet S is conveyed up to the trailing edge side. That is, even though the image forming position in the sheet width direction can be corrected to a position close to g1 at the leading edge portion of the sheet S, the image forming position may be misaligned to a position L1b at the trailing edge portion of the sheet S. In contrast, in the present embodiment, by detecting the side edge position at the center position of the sheet S, it is possible to prevent the image from being greatly misaligned with respect to the sheet S at the leading edge portion and the trailing edge portion of the sheet S.

The control unit 200 fixes the toner image via the fixing unit 50 (S112). In a case where the print job is single-sided printing, the sheet S on which the toner image is fixed is discharged to the sheet discharge tray 80. On the other hand, in a case where the print job is double-sided printing, the sheet S is reversed for forming an image on the second side (S113). The control unit 200 determines whether there is any subsequent printing (S114). When it is determined that there is no subsequent sheet (S114: NO), the control unit 200 terminates the print job (S115).

When it is determined that there is a subsequent sheet (S114: YES), the control unit 200 calculates an amount of image position correction in the sheet width direction on the first side based on the L1m detection result stored in the memory 202 (S116). Here, the control unit 200 takes over the correction amount in which the detection of the center position, g1n←L1m−g1(n−1), is considered to the subsequent sheet, and returns to the processing of step S103. That is, based on a first width position (L1m) at a first detection position of a first sheet that is a preceding sheet, the control unit 200 adjusts a position of an image to be formed on a second sheet that is a subsequent sheet conveyed after the first sheet. That is, based on the first width position (L1m) of the first sheet at the first detection position, the control unit 200 adjusts a position of an image to be transferred to the second sheet on the photosensitive drum 11. Note that the first sheet and the second sheet are not limited to being continuously conveyed, and in a case where sheets of different sizes are mixed, the same adjustment of the image forming position may be performed only for sheets of the same size.

When it is determined that the print job is printing on the second side (S103: NO), the control unit 200 reverses the sheet in a switched-back manner using the reverse conveyance roller pair 71, and conveys the sheet back to the pre-registration roller pair 41 by conveyance using the second conveyance unit 70b. The control unit 200 detects a side edge position (L2m) at the center position in the sheet conveyance direction on the second side of the sheet S, using the CIS 92, when the sheet S is conveyed by the second conveyance unit 70b (S117). That is, in a case where the first sheet is conveyed to the second conveyance unit 70b, the control unit 200 acquires a sixth width position (L2m) of the sheet in the sheet width direction at a third detection position serving as a fifth conveyance direction position, which is the center position, based on a detection result of the CIS 92. That is, based on a detection result of the detection result of the CIS 92, the control unit 200 acquires the sixth width position (L2m) of the first sheet, serving as a fifth sheet, in the sheet width direction at the third detection position located in a central region among three regions into which the first sheet conveyed by the second conveyance unit 70b is equally divided in the sheet conveyance direction. Then, based on the sixth width position, the control unit 200 adjusts a position at which an image is to be formed on the second side of the first sheet in the sheet width direction. That is, based on the sixth width position (L2m), the control unit 200 adjusts a position of an image to be transferred to the second side of the first sheet in the sheet width direction on the photosensitive drum 11. That is, the control unit 200 calculates an amount of image position correction in the sheet width direction on the second side based on the acquired L2m detection result, and writes an image at a g2n position, which is a calculated image position (S118).

The control unit 200 acquires a detection result of the registration sensor 43 with respect to the leading edge of the conveyed sheet S (S119), and the leading edge of the sheet S abuts against the nip portion of the registration roller pair 42 that has stopped. Thereafter, the sheet S is fed by the pre-registration roller pair 41 by a set feeding amount, so that a predetermined amount of deflection is formed in the sheet S (S120). In this manner, the control unit 200 corrects the skewing of the sheet S, and further initiates driving the registration roller pair 42 to be rotated (S121).

The control unit 200 continues the conveyance by the registration roller pair 42, and transfers an image (toner image) onto the sheet S in the secondary transfer unit 3 (S122). The subsequent processing is similar to the processing after S112.

As described above, in the image forming apparatus 1 according to the present embodiment, the control unit 200 adjusts a position of an image to be formed on the sheet S based on a first width position of the sheet at a first center position. Therefore, as compared with a case where a position of an image to be formed on the sheet S is adjusted based on the side edge position at the leading edge of the sheet, it is possible to reduce a positional misalignment of the image in the sheet width direction with respect to the sheet at the trailing edge of the sheet or the like. As a result, it is possible to improve the positional accuracy of the image formed on the sheet S in the sheet width direction.

### Second Embodiment

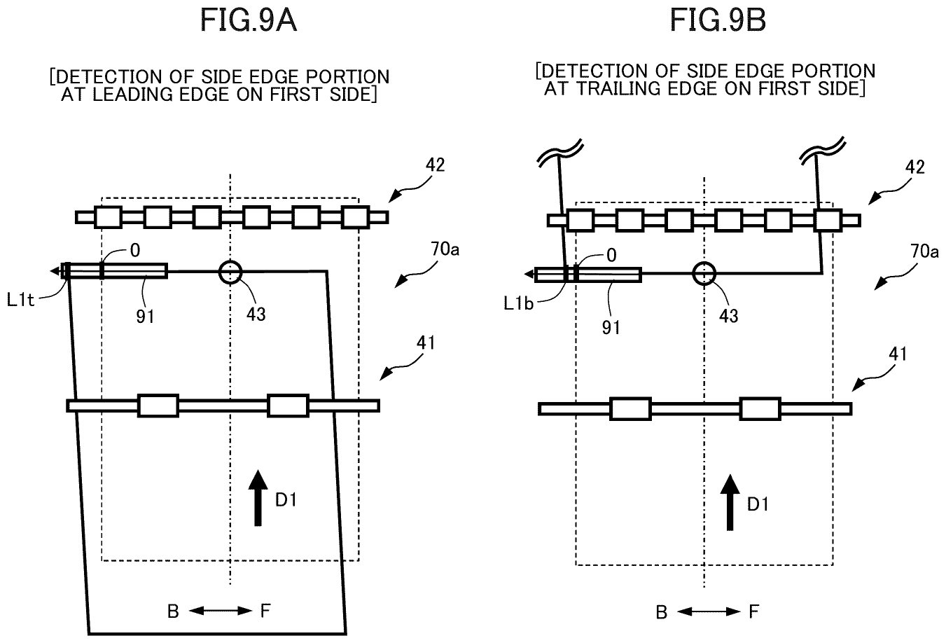

Next, a second embodiment of the present disclosure will be described in detail with reference to FIG. 9. The present embodiment is different from the first embodiment in that a side edge position at the center position is acquired using a side edge position at the leading edge of the sheet and a side edge position at the trailing edge of the sheet. However, other configurations are the same as those in the first embodiment, and thus, the detailed description thereof will be omitted with the same reference numerals. In the first embodiment, the case where the first width position is directly read by the CIS 91 has been described, but the detection of the first width position is not limited thereto. That is, side edge positions at positions other than the first detection position may be read by the CIS 91, and a first width position may be acquired by calculation based on results of detecting the side edge positions. In the present embodiment, such a case will be described.

FIG. 9A illustrates a state in which a side edge portion at a leading edge of a sheet is detected on the first side, and FIG. 9B illustrates a state in which a side edge portion at a trailing edge of a sheet is detected on the first side. The control unit 200 synchronizes a timing at which the side edge position at the leading edge of the sheet is detected by the CIS 91 with a timing at which the leading edge of the sheet arrives at the registration sensor 43, thereby making it possible to detect the side edge position at the leading edge of the sheet with high accuracy using the CIS 91. That is, the control unit 200 detects a second width position in the sheet width direction at a second conveyance direction position of the sheet S (a leading edge portion of the sheet S) in the sheet conveyance direction using the CIS 91. Similarly, the control unit 200 synchronizes a timing at which the side edge position at the trailing edge of the sheet is detected by the CIS 91 with a timing at which the trailing edge of the sheet passes through the registration sensor 43, thereby making it possible to detect the side edge position at the trailing edge of the sheet with high accuracy using the CIS 91. That is, the control unit 200 detects a third width position in the sheet width direction at a third conveyance direction position of the sheet S (a trailing edge portion of the sheet S) in the sheet conveyance direction using the CIS 91. Then, the control unit 200 calculates a first width position at a first detection position based on the second width position and the third width position.

In the present embodiment, the second conveyance direction position is the leading edge of the sheet, and the third conveyance direction position is the trailing edge of the sheet. However, the first and second conveyance direction positions are not limited thereto. As long as width positions can be detected at least at two conveyance direction positions, not limited to the leading edge and the trailing edge, the side edge position at the center position can be calculated.

According to the present embodiment, in order to acquire a side edge position at a center position of the sheet S, the center position is acquired by calculation from side edge positions at leading and trailing edges of the sheet, without directly measuring the center position. Since the side edge positions at the leading and trailing edges of the sheet can be acquired with high accuracy, the side edge position at the center position can also be acquired with high accuracy, and the image position can be corrected with high accuracy.

### Third Embodiment

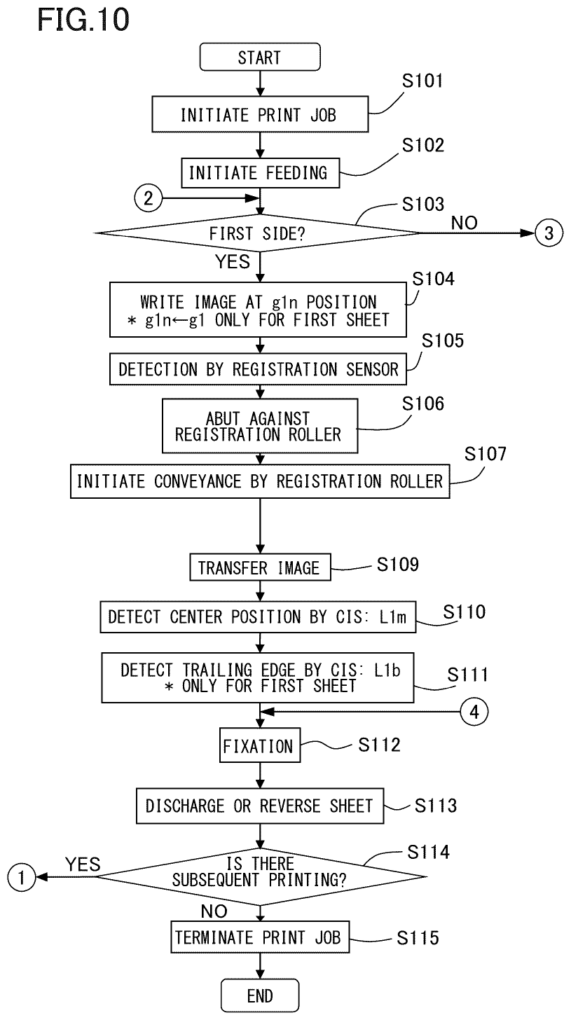

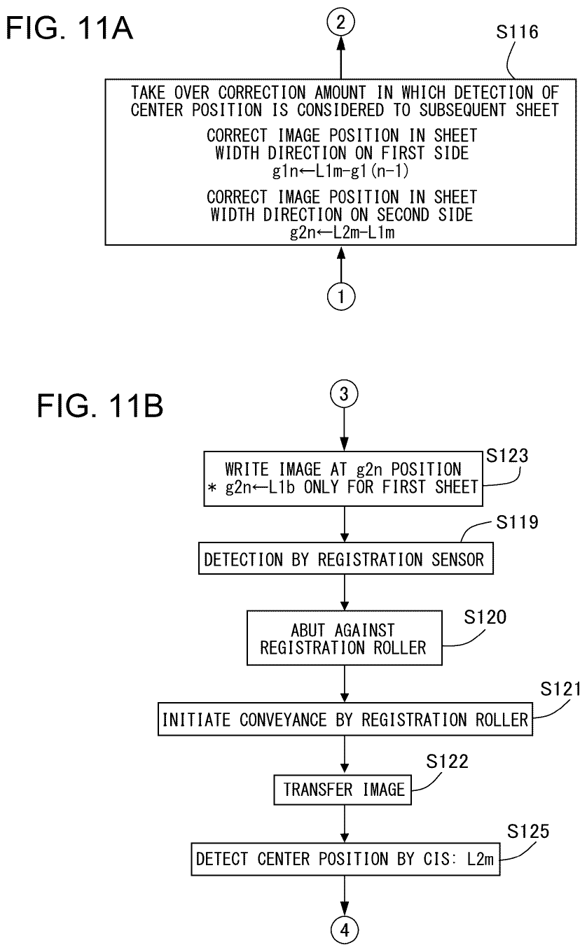

Next, a third embodiment of the present disclosure will be described in detail with reference to FIGS. 10 and 11. The present embodiment is different from the first embodiment in that the CIS 92 is not included. However, other configurations are the same as those in the first embodiment, and thus, the detailed description thereof will be omitted with the same reference numerals.

Hereinafter, a processing procedure for a method of detecting a side edge position in the width direction of the sheet S and correcting an image forming position in the image forming apparatus 1 will be described with reference to flowcharts illustrated in FIGS. 10 and 11.

Steps S101 to S110 are the same as those in the first embodiment. That is, the control unit 200 acquires L1m as the first width position on the first side of the first sheet based on the detection result of the CIS 91 (S110). After detecting the side edge position at the center position using the CIS 91 in step S110, the control unit 200 detects a side edge position at the trailing edge of the sheet using the CIS 91 as illustrated in FIG. 6B (S111), and stores a detection result L1b, for example, in the memory 202. Note that this detection is not executed for the second and subsequent sheets. Subsequently, steps S112 to S115 are the same as those in the first embodiment.

When it is determined that the print job is printing on the second side (S103: NO), the control unit 200 reverses the sheet in a switched-back manner using the reverse conveyance roller pair 71, and conveys the sheet back to the pre-registration roller pair 41 by conveyance using the second conveyance unit 70b. Here, the switched-back reversal is characterized in that the trailing edge side on the first side is switched to the leading edge side on the second side, and it is known that when the orthogonality of the sheet S is poor, the result L1b of detecting the side edge position on the trailing edge side of the first side correlates with the side edge position on the leading edge side of the second side. In reality, it is common that a misalignment during conveyance by the second conveyance unit 70b is also added.

In the present embodiment, taking into consideration the above-described phenomenon, an image writing position g2n on the second side is calculated based on the result L1b of detecting the side edge position on the trailing edge side of the first side, and g2n=L1b is set for the second side of the first sheet (S123). That is, in the present embodiment, in a case where an image is formed on the first side of the first sheet, the control unit 200 acquires a fourth width position in the sheet width direction at the trailing edge of the first sheet in the sheet conveyance direction based on the detection result of the CIS 91. That is, before the first sheet is reversed by the secondary transfer unit 3, the control unit 200 acquires a fourth width position in the sheet width direction at the trailing edge of the first sheet in the sheet conveyance direction based on the detection result of the CIS 91. Then, based on the fourth width position, the control unit 200 adjusts a position at which an image is to be formed on the second side opposite to the first side of the first sheet in the sheet width direction. That is, based on the fourth width position, the control unit 200 adjusts a position of an image to be transferred to the second side of the first sheet in the sheet width direction on the photosensitive drum 11.

Thereafter, steps S119 to S122 are the same as those in the first embodiment. As illustrated in FIG. 6A, the control unit 200 performs side edge position detection at the center position by the CIS 91 (S125), and stores a detection result L2m, for example, in the memory 202. That is, the control unit 200 acquires L2m as a fifth width position of the first sheet, serving as a third sheet, in the sheet width direction at a second detection position serving as a fourth conveyance direction position, which is the center position of the sheet S on the second side opposite to the first side of the first sheet, based on the detection result of the CIS 91 (S125). That is, based on the detection result of the CIS 91, the control unit 200 acquires L2m as the fifth width position of the first sheet in the sheet width direction at the second detection position located in a central region among three regions into which the first sheet conveyed by the first conveyance unit 70a and having passed through the second conveyance unit 70b is equally divided in the sheet conveyance direction.

Based on the obtained first width position (L1m), the control unit 200 adjusts a position of an image to be formed on the first side of the second sheet conveyed after the first sheet (S116). That is, based on the first width position (L1m), the control unit 200 adjusts a position of an image to be transferred to the first side of the second sheet in the sheet width direction on the photosensitive drum 11. Based on the obtained fifth width position (L2m), the control unit 200 adjusts a position of an image to be formed on the second side opposite to the first side of the second sheet serving as a fourth sheet (S116). That is, based on the fifth width position (L2m), the control unit 200 adjusts a position of an image to be transferred to the second side of the second sheet in the sheet width direction on the photosensitive drum 11. Specifically, as the image position correction in the width direction on the second side of the second or subsequent sheet, the control unit 200 takes over the amount of image position correction in which the detection of the center position, g2n←L2m−L1m, is considered, to the subsequent sheet (S116).

As described above, in the image forming apparatus 1 according to the present embodiment, since the CIS 91 detects the side edge positions at the center positions on both sides, the number of sensors can be reduced to one, and the number of components and the costs can be reduced.

According to the present disclosure, it is possible to improve the positional accuracy of the image formed on the sheet in the sheet width direction.

### OTHER EMBODIMENTS

In each of the above-described embodiments, the case where the center position where the first width position is detected is the center position of the sheet S in the sheet conveyance direction has been described, but the embodiment is not limited thereto. For example, it is only required that the center position be located in a central region among three regions into which the conveyed sheet S is equally divided in the sheet conveyance direction. This makes it possible to reduce a positional misalignment of the image in the sheet width direction with respect to the sheet at the trailing edge of the sheet or the like, as compared with a case where a side edge position is detected at the leading edge of the sheet.

In each of the above-described embodiments, an image is formed from the first sheet S, but the embodiment is not limited thereto. The first sheet may pass only for the purpose of detecting a side edge position without forming an image on the first sheet. In this case, image formation starts from the second passing sheet, and image positioning can be performed with high accuracy from the first sheet on which an image is formed.

In each of the embodiments described above, the case where the control unit 200 adjusts a position of an image to be formed on the sheet S in the image forming portion 2 has been described, but the embodiment is not limited thereto. For example, a moving mechanism capable of adjusting the position of the sheet S in the width direction may be provided, and the position of the sheet S may be adjusted based on the acquired side edge position at the center position.

In addition, in each of the above-described embodiments, the case where a position of an image to be formed on the sheet S in the image forming portion 2, that is, a position in the sheet width direction of an image borne on the photosensitive drum 11, is adjusted has been described, but the embodiment is not limited thereto. That is, the image forming position may be adjustable in the sheet conveyance direction or the rotation direction as well as the sheet width direction, and an optimum adjustment method may be selected according to the shape (distortion) of the sheet.

In the above-described embodiment, the image forming apparatus 1 adopts a vertical path configuration in which the conveyance path from the feeding units 31a and 32a to the secondary transfer unit 3 is upward, but the embodiment is not limited thereto, and a horizontal path configuration may be adopted.

In each of the above-described embodiments, the image forming apparatus 1 that is a color laser printer has been described as an example, but the embodiment is not limited thereto. For example, the present disclosure may be applied to an image forming apparatus that is a monochrome laser printer. Alternatively, the present disclosure may be applied to an inkjet printer.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-081284, filed May 17, 2024 which is hereby incorporated by reference herein in its entirety.

What is claimed is:

1. An image forming apparatus comprising:
an image bearing member;
an image forming unit configured to form an image on the image bearing member;
a transfer unit configured to transfer the image formed on the image bearing member by the image forming unit to a sheet;
a conveyance unit configured to convey the sheet on which the image is transferred by the transfer unit in a sheet conveyance direction;
a width position detection unit configured to detect a width position of the sheet in a sheet width direction intersecting the sheet conveyance direction; and
a control unit configured to adjust a position of the image on the image bearing member,
wherein the control unit is configured to acquire a first width position of a first sheet based on a detection result of the width position detection unit and adjust a width position of an image to be transferred to a second sheet subsequent to the first sheet on the image bearing member based on the first width position, where the first width position is a width position of the first sheet at a first conveyance direction position that is a position of the first sheet located in a central region among three regions into which the first sheet is equally divided in the sheet conveyance direction.

2. The image forming apparatus according to claim 1, wherein the first conveyance direction position is a center position of the sheet in the sheet conveyance direction.

3. The image forming apparatus according to claim 1, further comprising:
a length detection unit configured to detect a length of the sheet in the sheet conveyance direction,
wherein the control unit is configured to detect the first width position based on a detection result of the width position detection unit at the first conveyance direction position that is detected by the control unit based on the length of the first sheet detected by the length detection unit.

4. The image forming apparatus according to claim 1,
wherein the control unit is configured to detect a second width position based on a detection result of the width position detection unit at a second conveyance direction position of the first sheet different from the first conveyance direction position in the sheet conveyance direction,
wherein the control unit is configured to detect a third width position based on a detection result of the width position detection unit at a third conveyance direction position of the first sheet different from the first conveyance direction position and the second conveyance direction position in the sheet conveyance direction, and
wherein the control unit is configured to calculate the first width position based on the second width position and the third width position.

5. The image forming apparatus according to claim 4,
wherein the second conveyance direction position is a position of a leading edge of the sheet in the sheet conveyance direction, and
wherein the third conveyance direction position is a position of a trailing edge of the sheet in the sheet conveyance direction.

6. The image forming apparatus according to claim 1,
wherein the conveyance unit includes a registration roller pair disposed upstream of an image forming position where the image is transferred to the sheet by the transfer unit in the sheet conveyance direction, and
wherein the registration roller pair is configured to convey the sheet while being nipped after correcting skewing of the sheet by bringing a leading edge of the sheet in the sheet conveyance direction into abutment against the registration roller pair in a state where rotation of the registration roller pair is stopped.

7. The image forming apparatus according to claim 6, wherein the width position detection unit is disposed upstream of the registration roller pair in the sheet conveyance direction, and configured to detect a position of a side edge of the sheet.

8. The image forming apparatus according to claim 6, wherein the control unit is configured to acquire the first width position of the first sheet in a state where the first sheet is conveyed by the registration roller pair and reached to the transfer unit.

9. The image forming apparatus according to claim 1, wherein the control unit is configured to adjust the position in the sheet width direction of the image borne on the image bearing member.

10. The image forming apparatus according to claim 1, further comprising:
a reversing unit configured to reverse the sheet on which the image has been transferred on a first side by the transfer unit; and
a re-conveyance path along which the sheet reversed by the reversing unit is re-conveyed to the transfer unit,
wherein the control unit is configured to:
acquire a fourth width position that is a width position of the first sheet at a trailing edge of the first sheet in the sheet conveyance direction based on the detection result of the width position detection unit before the first sheet is reversed by the reversing unit; and
adjust a width position of the image to be transferred to a second side opposite to the first side of the first sheet on the image bearing member based on the fourth width position.

11. The image forming apparatus according to claim 1, further comprising:
a reversing unit configured to reverse the sheet of which the image has been transferred on a first side by the transfer unit; and
a re-conveyance path along which the sheet reversed by the reversing unit is re-conveyed to the transfer unit,
wherein the control unit is configured to:
acquire a fifth width position of a third sheet of which the image has been transferred on a first side by the transfer unit and that has passed through the re-conveyance path based on a detection result of the width position detection unit; and
adjust a width position, on the image bearing member, of an image to be transferred to a second side, opposite to a first side, of a fourth sheet, having passed through the re-conveyance path, subsequent to the third sheet based on the fifth width position, where the fifth width position is a width position of the third sheet at a fourth conveyance direction position that is a position of the third sheet located in a central region among three regions into which the third sheet is equally divided in the sheet conveyance direction.

12. The image forming apparatus according to claim 1, wherein the width position detection unit is a first width position detection unit,
the image forming apparatus further comprising:
a reversing unit configured to reverse the sheet of which the image has been transferred on a first side by the transfer unit;
a re-conveyance path along which the sheet reversed by the reversing unit is re-conveyed to the transfer unit; and
a second width position detection unit disposed in the re-conveyance path, and configured to detect a width position of the sheet in the sheet width direction,
wherein the control unit is configured to:
acquire a sixth width position of a fifth sheet of which the image has been transferred on a first side by the transfer unit and that has passed through the re-conveyance path based on a detection result of the second width position detection unit; and
adjust a width position, on the image bearing member, of an image to be transferred to a second side, opposite to the first side, of the fifth sheet based on the sixth width position, where the sixth width position is a width position of the fifth sheet at a fifth conveyance direction position that is a position of the fifth sheet located in a central region among three regions into which the fifth sheet is equally divided in the sheet conveyance direction.

13. The image forming apparatus according to claim 12, wherein the first width position detection unit and the second width position detection unit are disposed on a same side with respect to a center of a sheet conveyance region where the sheet is conveyed in the sheet width direction.
